(19) United States
(12) Patent Application Publication
(10) Pub. No.: US 2009/0276559 A1
(43) Pub. Date: Nov. 5, 2009

(54) Arrangements for Operating In-Line Memory Module Configurations

(75) Inventors: James J. Allen, JR., Raleigh, NC (US); Robert J. Reese, Austin, TX (US); Michael B. Spear, Round Rock, TX (US); Peter M. Thomsen, Hutto, TX (US); Michael R. Trombley, Cary, NC (US)

Correspondence Address: IBM CORPORATION (RTP);C/O SCHUBERT OSTERRIEDER & NICKELSON PLLC, 6013 CANNON MOUNTAIN DRIVE, S14, AUSTIN, TX, 78749, US

(73) Assignee: INTERNATIONAL BUSINESS MACHINES CORPORATION, Armonk, NY (US)

(21) Appl. No.: 12/114,533

(22) Filed: May 2, 2008

(51) Int. Cl. G06F 12/06

(52) U.S. Cl. 711/5; 711/E12.081

(57) ABSTRACT

In one embodiment, a method is disclosed for timing responses to a plurality of memory requests. The method can include sending a plurality of memory requests to a plurality of in-line memory modules. The requests can be sent over a channel from a plurality of channels, where each channel can have a plurality of lanes. The method can receive responses to the plurality of memory requests over the channel and monitor the response to detect a timing relationship between at least two lanes from the plurality of lanes. In addition, the method can adjust a timing of a register loading and unloading sequence in response to the monitoring of multiple lanes and channels. Other embodiments are also disclosed.

### FIELD

The present disclosure relates generally to memory systems and more specifically to controlling memory systems.

### BACKGROUND

Newer computing devices such as personal computers and servers continue to provide increased performance at a lower cost. Currently, many computing devices have multiple core processors and have multiple memory modules. In addition, many systems allow a user to add or expand memory capacity. Generally, the processing speed of a processor is many times greater than the speed or ability of a memory system to provide the processor with its basic requirements, (i.e. data and instructions). Thus, increasing the speed at which a memory system can store and retrieve data is an area of technology receiving increased research and development. Even a processor that is serviced by multiple memory modules typically can execute instructions faster than the multiple memory can store or retrieve data and code. Thus, there has been an increased emphasis on developing multiple memory module systems that can operate at faster speeds.

One type of economical memory is dynamic random access memory (DRAM). DRAM can be connected in a serial configuration directly to a processor or it can be connected via a bridge such as a north bridge. Fully buffered dual in line memory module (FBDIMM) configurations are an improvement over traditional memory configurations that utilize a parallel memory bus. A parallel configuration can create significant loading on signals traveling on the bus, and this can significantly limit the speed at which data can be sent over the bus. DIMMs that utilize advice memory buffers (AMB) are called FBDIMMs. Generally, FBDIMMs allow for multiple read channels and multiple write channels between the processors and memory. The AMB can provide a relatively high speed link to the bridge or processor and (DIMM) DRAM components.

An FBDIMM configuration has advantages over traditional systems in that the interconnection between the processor and memory can operate at much higher speeds, thus leading to increased operating speeds. This improved memory system can utilize impedance matched transmission lines such as micro strips or strip lines. An impedance-matched system allows for significantly faster data transfer over the bus and thus a much faster memory operation and overall system speed. Traditional computing systems do not have impedance matched lines and utilize a “stub bus” configuration where each memory module is stubbed off a trunk line in the parallel interconnect configuration. The impedance discontinuities of the parallel stub configuration can create reflected energy that interferes with signals on the bus and degrades the signal integrity, thereby limiting data transfer speeds.

An FBDIMM configuration buffers the DRAM data pins from the bus or channel. Such a configuration can be implemented such that the system does not have unconnected or exterminated “stubs.” Instead, it only uses point-to-point links. In a parallel configuration with transmission line terminations, high performance primary channels can be located or formed and lower performance secondary channels can also be located and formed. In addition, an outgoing connection referred to as a south bus can be created and an incoming connection or north bus can be created. These buses can be unidirectional as opposed to the traditional multi-directional bus to increase bandwidth. The south bus can carry commands such as a retrieval request and write data, while the north bus can parry retrieved data, instructions and other responses.

FBDIMM systems can be used to implement multiple channels. Many new systems can have as many as eight DIMMs per channel. In such a system, the north bus can consists of 14 bit-lanes (15 lanes for FBDIMM2) of data and can run at speeds as high as 9.6 GHz. For the north bus, a memory controller can utilize an input deskew adjust module to compensate for skew, or de-skew the bit lanes and to de-skew the different channels. Skew can be defined as the difference in the arrival times of data and instructions from memory across the bit lanes or channels. It can be appreciated that in response to memory retrieval requests, data on some bit lanes will arrive later than data on other bit lanes. This can be due to characteristics of the PCB board, the AMB and/or the processor core.

It can also be appreciated that a certain amount of clock drift and data skew often occurs in high speed memory systems. To handle the skew, which can be defined by up to 46 bit times between lanes, a memory controller can incorporate a north bus “de-skewer” or “de-skew macro” which can handle up to 64 bit times of de-skew. A drift component can also be implemented to work with an I/O interface to compensate for the drift. These two components, while helpful in meeting FBDIMM specifications, add latency or delay to the performance of the critical read data path.

### SUMMARY

The problems identified above are in large part addressed by the systems, arrangements, methods and media disclosed herein to improve the control, timing and coordination of data returning from a plurality of inline memory modules. Generally, the disclosed arrangements provide methods and systems to reduce memory retrieval latency across multiple components while adding an additional level of robustness to the memory retrieval process. The method can include sending a plurality of memory requests to a plurality of inline memory modules over a plurality of channels. Each channel can have a plurality of lanes.

In some embodiments, during a start up phase the system can self configure system timing and the system can become operable. Then, the system can continually adjust timing and move towards an improved timing settings that have improved latency and the system can increase timing margins for efficient lanes. However, sometimes improving on the latency may not provide a sufficient margin for drift compensation, and underruns may occur when the correct data is not available in the register during a read operation. If an underrun occurs, the method can dynamically adjust system timing with minimal impact (i.e. without having to perfume a disruptive reset causing a significant delay). In some embodiments, the method can receive responses to the plurality of memory requests over a channel and can monitor the responses in the plurality of lanes in a channel for possible error conditions. Based on detected parameters and/or error conditions, the method can dynamically adjust and improve the timing of a register loading and unloading sequence. The method is first configured for minimum potential latency. This configuration may fail due to underruns in the drift compensation register loading and unloading sequence, in which case the means exist to dynamically adjust the sequence with minimal impact. For lanes that return data early, the loading/unloading commands can be given additional separation to provide an additional safety margin to improve the robustness of the system. Such a dynamic process can reduce latency and increase reliability and robustness of a memory retrieval system.

The method can also include transmitting a test or training sequence to the plurality of inline memory modules and, based on the arrival time from lanes and channels, set the timing of the register loading and unloading sequence. In some embodiments, the method can include detecting a lane in a channel with the largest latency (i.e. delay time) or a larger delay time than other lanes in the channel, and reduce a time interval between register loading and unloading in the lanes with the greatest latency. In addition, the method can increase the load/unload time interval for the faster lanes to increase system robustness. Such a dynamic adjustment (reducing the register throughput delay on slow channels and increasing or keeping a standard delay on faster channels in the registers) can reduce overall system latency and improve system performance.

Accordingly, the robustness of the data retrieval system can be improved by detecting another lane in the channel with a smaller time delay than at least one other lane and increase a time interval between register loading and unloading in the other lane. In yet other embodiments, timing adjustments can be performed in response to measured or monitored timing parameters of the received reply. Timing adjustments can also be performed in response to detecting an actual or potential underrun. An underrun can occur where the data is ready and the data is unloaded from a register too early. Initially, compensation for skew can be achieved across the channels based on the results of the training patterns which can be utilized to calibrate the system.

In another embodiment, an apparatus is disclosed that includes at least one lane to convey a memory retrieval request and at least two lanes to receive results associated with the memory retrieval request. The apparatus can also include a drift compensation module coupled to the receiving lanes. The drift compensation module can utilize a load command and an unload command to control loading or storing and unloading or reading, and transmitting conveying signals into and out of a register. The load and unload commands can have a timing relationship which can be altered to change system performance. For example, the unloading command can be delayed from the load command less than one full clock cycle or more than one clock cycle. Such a delay can provide lower latency and a high reliability for a memory system.

The system can also include a monitor for system parameters that can send a control signal to the drift compensation module. Thus, in real time the control signal can adjust timing relationships of the memory retrieval system including the timing relationship of the load and unload control signals. In some embodiments, the apparatus can include a deskew module connected to the drift compensation logic input port that can deskew the results that are received on different channels.

In yet another embodiment, a machine-accessible medium is disclosed. The medium can include instructions to operate a processing system which, when the instructions are executed by a machine, cause the machine to send a memory request to at least two inline memory modules. In addition, the machine can receive a reply to the memory request on at least two lanes and at least two channels and can monitor the reply to detect actual or potential data retrieval errors or system errors. The machine can also compensate for timing drift between data sequences being received in different lanes by adjusting a timing of a register loading and an unloading. Such adjustment can be controlled based on monitored parameters.

### BRIEF DESCRIPTION OF THE DRAWINGS

Aspects of this disclosure will become apparent upon reading the following detailed description and upon reference to the accompanying drawings in which like references may indicate similar elements.

FIG. 1 depicts a high-level block diagram of a processing system;

FIG. 2 illustrates compensation logic and drift adjust logic subsystem;

FIG. 3 is a flow diagram for initializing a drift compensation system; and

FIG. 4 is a flow diagram for retrying when a retrieval error occurs.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

In one embodiment, a method for fine-tuning the timing of a memory system is disclosed. Initially, a system can initialize itself and commence operation. The method can then send a plurality of memory requests to a plurality of inline memory modules. The requests can be sent over a channel from a plurality of channels, where each channel can have a plurality of lanes. The method can receive responses to the plurality of memory requests over the channel and monitor the response to detect a timing relationship between at least two lanes. In addition, the method can adjust a timing of a register loading and unloading sequence in response to the monitoring.

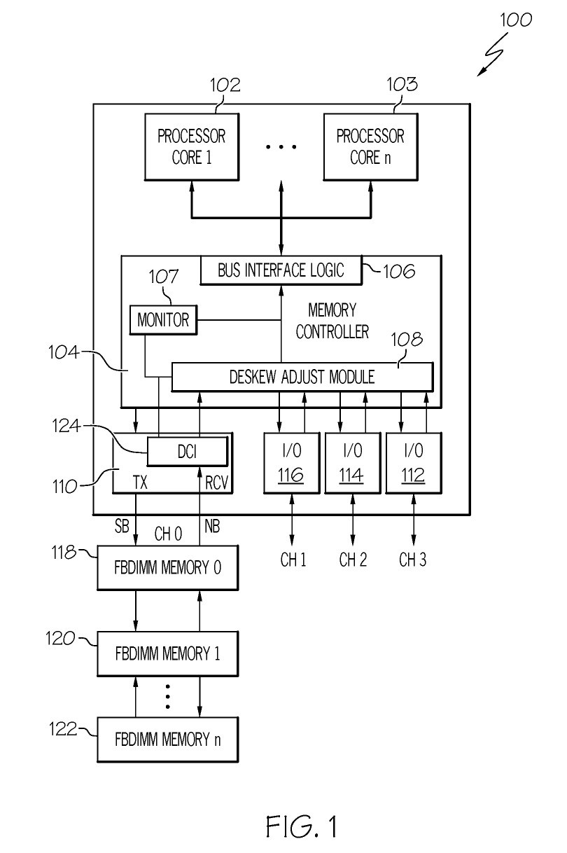

Referring to FIG. 1, a processor-memory system 100 is depicted that can achieve dynamic control of data flow in response to monitored system parameters. The system 100 can include a number of processor cores illustrated by processor cores 102 and 103. The processor cores 102 and 103 can interface the bus interface logic 106 and the deskew adjust module 108 of the memory controller 104. The deskew adjust logic 108 can deskew data returning from dual in line memory modules (DIMM) on the north bus (return data) from many different input output (I/O) modules such as I/O modules 110, 116, 114 and 112. In some embodiments, four different channels (i.e. channels 0-3) can be serviced by memory controller 104. In other embodiments, any number of channels can be accommodated.

The system 100 can include a first memory channel with multiple fully buffered dual in line memory modules (FBDIMM) such as FBDIMMs 118, 120, and 122. In the illustrated embodiment, channel zero may consist of memory 0, 118, memory 1, 120, . . . and memory “n” 122 to store data and instructions that can be utilized by processors 102 and 103. The south bus (SB) can convey outgoing memory request communications to the DIMMs 118, 120 and 122 and the north bus (NB) can convey data or instructions returning from DIMMs 118, 120, and 122.

The DIMMS 118, 120 and 122 can be connected in a serial configuration where DIMM 0, 118 is the first to receive the request, then DIMM 1, 2 and so on until the request reaches DIMM (n) 122. In response to art initialization process, the last detected DIMM (i.e. DIMM n) can “turn the request around” and send a reply to the request back to the processor cores 102 and 103 via the north bus. During this initialization process, DIMM (N) 122 can detect that it is the last in a “daisy chain” and can function as the “end of the line” and turn all southbound traffic to northbound traffic based on this detection.

Monitor 107 can monitor many system parameters such as return times for responses to replies on individual lanes and on different channels. In response to monitored parameters and/or error signals monitor 107 can select a type of corrective measure such as a timing change, a soft reset, a fast reset, or a hard reset. For example, monitor 107 can monitor the timing of control signals in the system 100. Also, monitor 107 may modify the timing of read and write signals, or load and unload signals for a specific register based on return times from various channels and various lanes. Monitor 107 can also send control signals to correct actual or potential timing or operational problems.

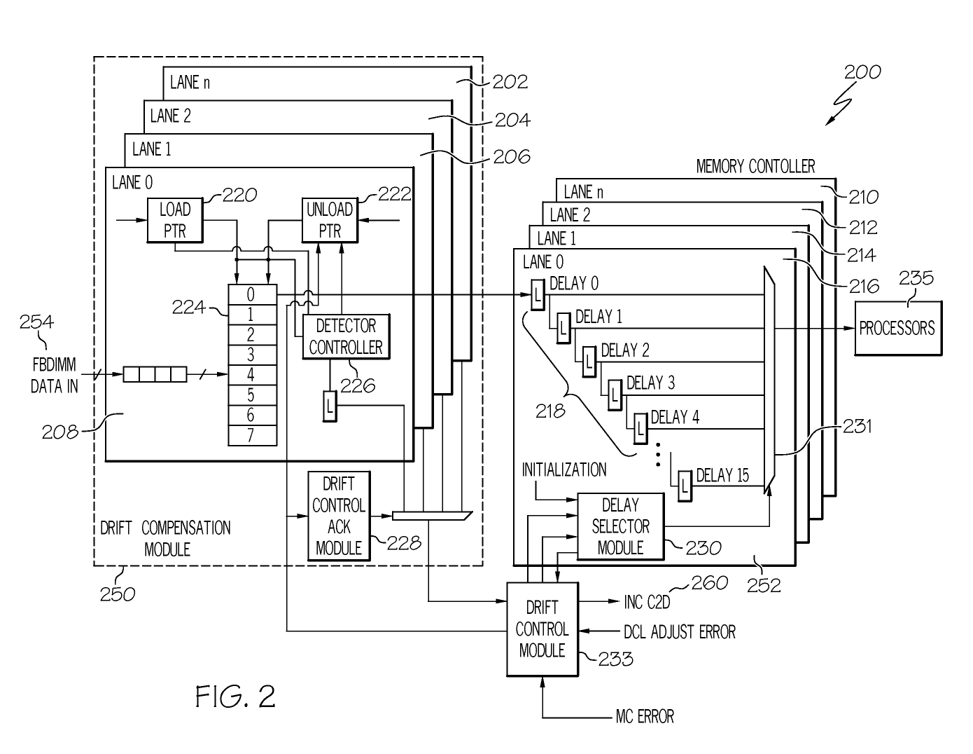

Referring to FIG. 2, one embodiment of a deskew adjust module and a drift compensation logic are illustrated in more detail. In operation, detector/controller 226 can monitor and detect system parameters and send control signals to the load and unload pointers 220 and 222 during system operation. Such control signals can provide dynamic control of system timing in response to detected system parameters. As illustrated, drift compensation logic module 250 can control eight inputs where each input is provided to a first in first out (FIFO) module. One such FIFO module for lane 0, 208 is illustrated by FIFO module 224. There can be many lanes such as lane 0, 208, lane 1, 206, lane 2, 204 . . . and lane n, 202.

FIFO module 224 can absorb drift or adjust the drift on incoming lanes such as NB lane 254. These can be north bound lanes according to FIG. 1. This FIFO configuration can be implemented with a load pointer 220 which can be clocked by a clock whose timing is adjusted by detector/controller 226 and an unload pointer 222 which can be clocked by the memory controller system clock as adjusted by detector/controller 226. The relationship of the timing outputs of load pointer 220 and unload pointer 222 can be detected or monitored by detector/controller 226 and the timing relationship can be altered via control outputs of detector/controller 226 to improve system performance.

The system 200 can include multiple lanes (202-208) where the timing of each lane can be altered to accommodate drift compensation. In addition, each of the multiple lanes (210-216) can be deskewed by the memory controllers such as memory controller 252. All lanes can receive incoming data from the FBDIMM north bus channel 254. In one embodiment, the system 200 can process fourteen lanes, however this is not a limiting feature. Data can pass through the drift compensation logic modules such as drift compensation logic module 250 for lane 1 and then pass to memory controllers such as memory controller 252 for lane 1, where the data can remain in a per lane format.

Drift control module 233 can monitor and determine skew across the different lanes (i.e. lanes 0-n) via reading the output of a multiplexer that is controlled by drift control acknowledgement module 228. The drift control module 233 can accept timing signals and error signals and can send control signals to the delay selector module 230. Thus, the drift control (ctl) adjustment module 233 can send control signals to delay select module 230 such that the drift control module selects a delay interval via control of multiplexer 231. The memory controllers such as memory controller 252 can delay data moving from the FIFO module 224 to the processors 235 according to memory retrieval protocols. Although the lane described is a single lane, (Lane 0) the described functions can occur on all lanes (i.e. Lanes 0-n). Thus, based on monitored parameters and control inputs, the drift control module 230 can select a particular delay by controlling what delayed signal is passed to the output of the multiplexer 231.

Initially, or on system start up, the system 200 can place the timing in a default mode that provides a basic timing configuration. The start-up or setup process can be performed on each FBDIMM channel. The setup process can include sending training patterns (known memory retrieval requests that exercise specific areas of memory) and based oil the timing of the retrieved signals and other parameters, the system 200 can determine system parameters and set up the system timing operations for each lane. This process can be iterative and can send control signals to many different components before the system becomes “tuned.” In one embodiment, all lanes can be initially set to a specific delay such as a zero delay. The slowest lanes can remain set at a minimal or zero delay, and all faster lanes can be set with larger delays to slow the transfer of data in these faster lanes. This setup procedure can synchronize the lanes by slowing the faster lanes while not significantly delaying or not changing the timing for the slowest lanes.

In some embodiments, the load pointer 220 and the unload pointer 222 timing can be set, and deskew delay can be selected via delay modules 218, upon the power up initialization process. As stated above, trained patterns can be utilized to initialize and/or calibrate system timing. The training patterns can be a predetermined data pattern that is transmitted by the Memory controller on the South Bound Lanes, wrapped by the last FBDIMM from SB to NB lanes and recaptured in the memory controller. System parameter data such as delay data can be determined from training patterns where such delay data can be stored in a local data store (such as a read buffer), during the setup process. In accordance with some embodiments, system delays can be learned and system timing can be set or adjusted according to these learned delays.

Generally, analyzing the results produced by the received training patterns in the data store allows for the determination of the relative timing of channels and lanes. This initial setup may not be an optimal set up, but can create a functional system. Although this initial timing may not be optimal, during subsequent operation, the detector/controller 226 and other monitoring components can detect problems and potential problems and help tailor or fine-tune the control signals to improve system timing and system performance.

The drift compensation module 250 can receive high-speed serial data from the FDDIMMs and the data can be accumulated in four-bit segments. Each four-bit segment can be presented to, and stored by the four-bit wide FIFO module 224 at one fourth of the serial data rate. The incoming retrieved data can be written info the eight-entry or eight register file FIFO module 224 by the load pointer 220. The control signal from the unload pointer 222 can indicate the four bits of data which can be removed from or read from the FIFO module 224.

The load pointer 220 can point to, or activate a register in the FIFO module 224, where the register can be loaded with incoming data or instructions. Unload pointer 222 can point to, or can activate a register that has stored data, where the data can be unloaded the next clock cycle. This unloaded data can be forwarded to the memory controller 252. The number of clock cycles between loading and unloading the FIFO module 224 can contribute to the latency of the system. Detector/controller 226 can operate to minimize the number of clock cycles between loading and unloading of the FIFO module 224. In addition, drift times associated with the retrieved data can be compensated for, or absorbed by the timing offset between the load and unload pointers 220 and 222.

The system 200 can have a fixed or default timing offset or timing delay between the load and unload pointer 220 and 222 as configured during a startup mode. The default setting can be four registers, entries or clock cycles, thus, allowing the “maximum” drift. In some embodiments, the detector/controller 226 can detect when the load pointer 220 and the unload pointer 222 signal deviates from a predetermined range of acceptable values. The detector/controller 226 can detect when the timing differential between the pointers 220 and 222 get out of the acceptable range of values, and the detector/controller 226 can make timing corrections. A timing adjustment by the detector/controller 226 can be triggered when the load and unload signals are too far apart, too close together or become equal.

In other embodiments, detector/controller 226 can determine if an underrun or an overrun has occurred (i.e. premature read or a premature write). Detector/controller 226 can activate delay components to provide the desired delay for an unload pointer, if detector/controller 226 detects an error on the lane controlled by the unload pointer. Detector controller 226 can monitor for overruns and can provide an overrun error signal to the drift control module 233. This error signal can be sent to the latch connected to the detector/controller 226 and the signal can be clocked through a multiplexer by the drift control acknowledgement (ACK) module 228 to the drift control module 233. Drift control module 233 can make timing adjustments to the unload pointer 222 via a control line in response to the error signal. The drift control module 233 can also send an adjust signal to the delay selector module 230 based on this error signal.

In one embodiment, the drift control module 233 can have master control of the modification of timing signals where no timing changes are made unless the DCL adjust signal from the drift control module 233 is asserted. In some embodiments, and with some detected failures, the drift control module 233 can send a soft reset to various components. This soft reset can be initiated by the monitor 107 in FIG. 1 (not shown in FIG. 2) and such a soft reset can be achieved in accordance with the Joint Electronic Devices Engineering Council (JDEC) FBDIMM specification published May 4, 2006.

As stated above DIMMs that utilize advance memory buffers (AMB) are called FBDIMMs. In some embodiments the AMBs can be reset to a known state when a soft reset is issued to the FBDIMM interfaces. A soft reset can allow the system 200 to recover from a failure without a hard reset. A soft reset can return the system 200 to a previous state and the system can “re-execute” code that was loaded for processing previous to the soft reset. Thus, the system will get delayed only by a minimal number of clock cycles when a soft reset occurs.

Alternately, a soft reset of the system can be triggered when the system detects a parameter that does not meet a predetermined criterion. It can be appreciated that the soft reset only creates a brief interruption to system operation. Traditional systems and methods typically utilize a hard reset when system performance is out of tolerance. Such a hard reset can create a major disruption in processing where the system reboots and re-initializes during the hard reset. Traditional resets based on errors can also stall the system for minutes as the system “retrains” or recalibrates memory system timing, among other things. In some embodiments, the memory controller (104 in FIG. 1 and 252 in FIG. 2) can store memory requests sent by the processor(s) and in the event of an out of tolerance condition a soft reset can be initiated. During a soft reset, the memory controller can place the processors 235 in a standby mode for a few cycles and resend the previous memory write and read requests to the FBDIMM(s) (not shown).

The processors 235 can be restarted and can resume operation of the process from the location in the code when the processors were placed in standby, when the results of these “resent” memory requests are returned and placed in the data store. It can be appreciated that when such an error occurs in a traditional system the system invokes a hard reset which commences system retaining sequence. Such a retraining is a time consuming and disruptive process.

A soft reset can occur when a previous request for data was not fulfilled because of data errors due to timing issues and such an error has been detected. In some embodiments, a soft reset, in accordance with the FBDIMM standard, can be a command that stalls some components and resets only a few components where only a minimal number of clock cycles are “unproductive.” For example, the soft reset can resend a previous request and when the results are retrieved, the system can resume processing where it left off. To the contrary, a hard reset can place the system back into an initialization mode or a calibration mode and thus can create a time intensive recovery and can be very disruptive to the processing.

The timing separation between the load and unload pointers 220 and 222 can be less than one full clock cycle, one clock cycle or the timing separation can be multiple clock cycles. Such a separation can compensate for the clock drift in the data retrieval and thus retrieval delays can be absorbed by the load/unload timing of the FIFO module 224. Generally, the greater the time separation/delay between the load and unload pointers 220 and 222, the more drift compensation that is provided by the system 200. However, the greater the time differential or timing separation between the load and unload control signals, the greater the latency of data retrieval.

In some embodiments, detector/controller 226 can continually monitor load and unload pointers 220 and 222 as the system is operating. As stated above, dynamic timing adjustments can be made in response to the detection of system parameters, such as detection of timing, timing delays and the detection of errors. These dynamic timing adjustments can be implemented while the system is operating, after an initial timing set up. For example, detector/controller 226 can analyze load and unload timing that is likely to cause errors while the system is operational. Detector/controller 226 can also determine if timing can be altered to improve system latency. As stated above, an overrun can occur when the unload pointer 226 unloads a register file such as register files 0-7 of the FIFO module 224 before the proper data has been placed in the register file.

It can be appreciated that this monitoring and dynamic calibration for reading and writing, or loading and unloading, allows the timing of the load and unload pointers 220 and 222 to be set very close. In some embodiments, the load command and unload signals or unload command can be automatically adjusted such that they occur within a single clock cycle. Alternately described, the load and unload command can be separated by less than one clock cycle. If a minimal clock drift for the pointers (220 and 222) occurs at such a “high performance” setting, (i.e. less than one clock cycle between the load and unload command), the detector/controller 226 can detect this and send a status signal to the drift control module 233 requesting the drift control module 233 to increase the timing separation between the pointers 220 and 222.

It can be appreciated that the load/unload timing relationship can be set based on actual operating performance. Thus system performance can be increased by altering system timing to a setting just below a setting where too many errors occur or to a setting proximate to where errors are not too likely to occur. For example, the pointers 220 and 222 can be set less than one clock cycle apart (the same clock cycle with slight time delay for read and write), one cycle apart, or two cycles apart in response to actual system performance. An acceptable or unacceptable data error rate may also trigger a timing modification. Zero, one and two clock cycle separations between the load and unload pointer 220 and 222 can significantly reduce system latency of the system 200, as compared to traditional systems that utilize a fixed three, four or five entry separation to achieve acceptable, yet less than perfect operation.

The latency of the disclosed system can provide a significant improvement over traditional data retrieval systems because the disclosed system can dynamically calibrate its timing configuration on loading and unloading of registers and when the timing get so close that errors are likely to occur, or do occur, then after a soft reset and a simple dining adjustment the system again becomes operational. Generally, different manufacturing batches or lots will have different manufacturing tolerances. In traditional systems, setting the load/unload time differential at less than three cycles can significantly reduce a manufacturing yield and can increase the chance of operational data errors. Data errors can be caused by many things, such as by drift that can occur on the clocks signals that control the load pointer 220 and the unload pointer 222.

It can be appreciated that some chips can be physically superior to other chips where both chips are built based on the same design. A chip having minimal manufacturing deviations and/or minimal tolerance build up can provide exceptional operating qualities, thus having operational performance that is significantly better than chips from other lots. The disclosed dynamic calibration arrangements can fine tune higher quality chips so that these physically superior chips can run at higher frequencies. This provides higher performance chips because each chip is not limited by a factory preset operating speed that has been assigned to the chips to create a desired yield for each lot. In addition, chips that are physically superior can operate at an increased speed because the disclosed dynamic tuning can find a preferred operating point. It can be appreciated that each chip or system does not have to be set to a single low performance timing configuration such that the manufacturing yield is acceptable. In addition, the dynamic timing corrections provided by the disclosed system can adapt the system timing over time as device performance, temperature etc. changes.

In some embodiments, the system 200 can set the load/unload pointer delays differently for each lane based on the amount of detected skew for each lane. In one embodiment, the lane with the largest skew can be assigned the smallest load/unload timing separation, and the lane with the smallest skew can be assigned the largest load/unload timing separation. For example, the pointer offset or timing differential for lane 0, 208 FIFO could be set to one full clock cycle and lane 1, 206, lane 2, 212 and all other lanes could decrease their deskew (offset) by one or two clock cycles or increase their load/unload pointer timing offset by one or two increments, if lane 0, 208 has the most retrieval latency of all lanes. This additional separation can improve reliability or robustness for paths without having an effect on system latency.

Stated another way, this “cushion” or design margin can keep the data arrival time at a high level and also allow more pointer separation in the drift compensation logic (load/unload). This separation can decrease the likelihood of a FIFO underrun on these lanes with this lower latency. The memory controller 252 can be responsible for adjusting data timing on the north bus lanes to reduce, control or eliminate the skew between lanes 0-n.

The system 200 can also incorporate different detection schemes for errors. For example, a cyclic redundancy check (CRC) system can provide additional error detection/correction to the system 200. A CRC generally is an error detection arrangement that executes a long division computation in which the quotient is discarded and the remainder becomes the result, with the important distinction that the arithmetic used is the carry-less arithmetic of a finite field. In addition, other error detection/correction schemes could be implemented.

During a soft reset sequence, the drift control module 233 of the memory controller 252 can issue a drift control logic (DCL) adjust command to the drift compensation module 250. The drift compensation module 250 can respond by issuing a DCL adjust status response to the drift control module 233. This response can begin with a start bit for one clock cycle. The status for each bit lane can immediately follow the start bit and can be presented for one clock cycle starting with lane 0 and ending with lane 13. A status bit of ‘1’ can indicate an underrun condition has occurred. Accordingly the detector/controller 226 can increment the pointer timing differential by one, for all lanes with an underrun error.

In some embodiments, each detector/controller in each lane that detects an underrun can set the load/unload timing differential to a predetermined separation where each lane has the same timing configuration. In addition, the deskew delay provided by delay selector 230 for the under running lanes can be decremented or delayed by one increment. If all deskew delay values are 0 or greater, the DCL adjust, or the setting for the load/unload timing separation, can be considered complete until the detector/controller 226 detects an but of tolerance condition. The command to data (C2D) delay signal 260 can be incremented by one for all lanes, and the deskew delay (load/unload separation) for all lanes can also be incremented by one, if one or more of the delay values in the memory controllers (such as memory controller 252) are less than zero. This process can adjust all lanes with underruns such that they have an additional clock separation increment between the load and unload pointer 220 and 222. As a result, the FBDIMM channels can remain properly timed, and a full FBDIMM initialization may not be required.

In some embodiments, the load, unload timing separation for each lane that lane that is not the slowest in the channel can be increased one increment and the delay selector can for decrease to compensate for the increase delay for each of these lanes. Thus, the timing for all lanes can be modified to increase robustness instead of only adjusting the lanes with underruns. This adjustment can possibly eliminate and will typically reduce the need for the drift compensation modules 250 to be controlled by the drift compensation logic adjust status signal from the drift control module 233. This approach or arrangement may hot create performance concerns, since all of the fast lanes can be “padded” with desirable tolerance during the initialization process. This arrangement may cause an overrun, but because the FIFO register 224 has eight entries and this arrangement is only padding up to two, such a configuration in most cases will provide a sufficient timing margin. This arrangement can also reduce the need to utilize underrun detection logic.

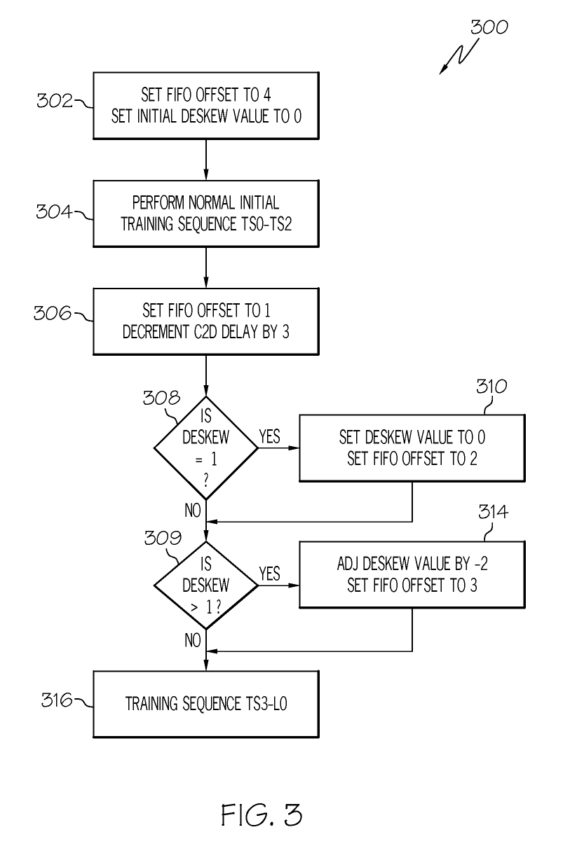

Referring to FIG. 3, a method is disclosed for calibrating a DIMM based memory system. As illustrated by block 302, all unload pointer offsets can be set to a value on the order of four clock cycles. Four clock cycles can be considered as a “maximum” desirable load/unload timing separation that will allow most systems to acceptably operate during start up. A four clock cycle load/unload separation can theoretically provide good underrun and overrun protection, but generally creates excessive latency or less than perfect tuning. It can be appreciated that such separation can add four cycles of latency to system operation which is undesirable.

In addition, the initial delay can be set to zero for all lanes, as illustrated in block 302. The FBDIMMs can be initialized and the last FBDIMM in a channel can be identified and set to terminate the south bus and originate the north bus, as illustrated by block 304. The FBDIMM can be provided with a predetermined “training” sequence during the initialization. The training sequences can be labeled as TS0, TS1 and TS2. In the TS0 state, the skew for each lane can be determined and adjustments can be made to the deskew adjust module. TS1 can be a diagnostic training sequence and the TS2 training sequence can be a test to determine the command-to-data (C2D) delay. These training sequences are defined in Joint Electronic Devices Engineering Council (JDEC) FB-DIMM specification published May 4, 2006.

A command-to-data (C2D) delay signal can represent the delay in time from the issue of the read command on the south bound bus to the return of corresponding response on the north bound bus for a particular lane. The C2D delay signal can be utilized to determine when to expect read data in response to a read or retrieve command. As illustrated in block 306, the FIFO offset can be set to one clock cycle and because the received data can be three cycles earlier, the C2D delay can be reduced by three clock cycles.

As illustrated by decision block 308, additional robustness might be added to the lane/system by changing the timing to placing additional margin in these faster lanes, as illustrated by block 310, if the deskew for the lane under analysis is set at one or is equal to one. The change in settings can place additional margin for the faster lanes or for lanes that are not the slowest, and the system can add more margin to the FIFO module load/unload offset by reducing the deskew delay by one and increasing the FIFO load/unload timing separation by the same amount, as illustrated by block 310. At decision block 308, if the deskew for a lane is not equal to one, then it can be determined at decision block 309 if the deskew is greater than one. As illustrated by block 314, the deskew value can be reduced by two and the FIFO load/unload timing offset can be set to three, if the deskew is greater than one. As illustrated by block 316, the initialization of the FBDIMM can also include running a TS3 configuration sequence and then transitioning to the fully initialized state (referred to as of L0). The above described arrangements can allow the drift control FIFO timing offset to be dynamically increased if an error has been detected on a channel. The memory controller can issue a soft reset for errors detected by the memory controller on this interface, such as CRC errors, alerts or frame alignment errors. The soft reset can be a first level of recovery of errors and a sequence defined by the FBDIMM specification can be utilized.

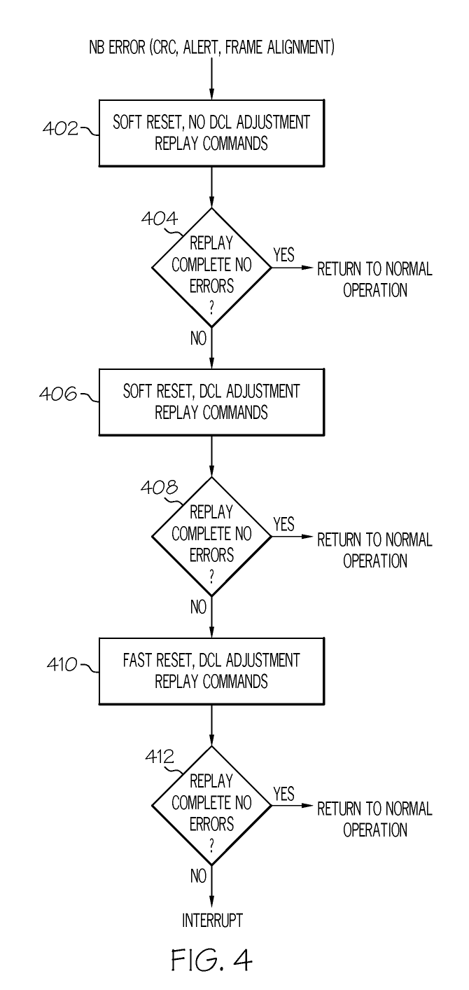

Referring to FIG. 4, a method for a recovery sequence that can be implemented for a FBDIMM system after an error is detected, is illustrated. In some embodiments, many different monitors and monitoring mechanisms can detect many different types of errors and generate error signals in response to such error detections. For example, an error signal can be issued by a north bus error detector, a CRC type detector, an alert detector or a frame alignment detector. As illustrated by block 402, the system can generate a soft reset sequence when the system receives an error signal such as an NB error signal, a CRC error signal, an Alert error signal, or a frame alignment error signal. In some embodiments, the soft reset sequence will not have a drift compensation adjust control command. It can be appreciated that FBDIMM errors can be caused by many conditions, and some of these conditions or errors may not reoccur. Therefore, a soft reset and retry in response to an initial error may provide an acceptable solution to the detected error without the need for a drift compensation adjustment. The commands can be reloaded and replayed.

As illustrated by decision block 404, it can be determined after the replay is complete if there are any errors. The memory controller can return to normal operation if the replayed commands are executed without error. Another soft reset can be issued, in cooperation with a drift compensation adjustment, as illustrated by block 406, if another error condition occurs before, during, or after the replay. The soft reset sequence can initiate the drift compensation adjust sequence. All outstanding commands can be retried, replayed or re-executed, once the soft reset sequence is completed. As illustrated by decision block 408, the memory controller can return to normal operation if replayed commands are executed without error. A fast reset sequence can be issued if another error condition occurs. A fast reset sequence can prompt a fast initialization sequence for the FBDIMM interface. A drift compensation adjust sequence can also be issued during the fast reset and the commands can be replayed.

This fast reset process can allow adjustment for an underrun that has occurred since the last drift compensation adjustment. As illustrated by decision block 412, the outstanding commands can be replayed and it can be determined if any errors are detected at the end of the fast reset sequence. The memory controller can return to normal operation if all replayed commands are completed without error. An interrupt can be generated and can be sent to the service processor and a hard reset can occur if another error condition occurs.

An implementation of the process described above, may be stored on, or transmitted across, some form of computer readable media. Computer readable media can be any available media that can be accessed by a computer. By way of example, and not limitation, computer readable media may comprise “computer storage media” and “communications media.” “Computer storage media” includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer. “Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

Reference to particular configurations of hardware and/or software, those of skill in the art will realize that embodiments of the present disclosure may advantageously be implemented with other equivalent hardware and/or software systems. Aspects of the disclosure described herein may be stored or distributed on computer-readable media, including magnetic and optically readable and removable computer disks, as well as distributed electronically over the Internet or over other networks, including wireless networks. Data structures and transmission of data (including wireless transmission) particular to aspects of the disclosure are also encompassed within the scope of the disclosure.

Each process disclosed herein can be implemented with a software program. The software programs described herein may be operated on any type of computer, such as personal computer, server, etc. Any programs may be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet, intranet or other networks. Such signal-bearing media represent embodiments of the present disclosure when carrying computer-readable instructions can direct the functions of the disclosed arrangements.

The disclosed embodiments can take the form of an entirely hardware embodiment, an entirely software embodiment or an embodiment containing both hardware and software elements. In a preferred embodiment, the invention is implemented in software, which includes but is not limited to firmware, resident software, microcode, etc. Furthermore, the invention can take the form of a computer program product accessible from a computer-usable or computer-readable medium providing program code for use by of in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. A data processing system suitable for storing and/or executing program code can include at least one processor, logic, or a state machine coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

What is claimed is:

1. A method comprising;
sending a plurality of memory requests to a plurality of in-line memory modules over a channel from a plurality of channels, each channel having a plurality of lanes;
receiving responses to the plurality of memory requests over the channel;
monitoring the response to detect a timing relationship between at least two lanes from the plurality of lanes; and
adjusting a timing of a register loading and unloading sequence in response to the monitoring.

2. The method of claim 1, further comprising determining a lane in a channel with the larger time delay than other lanes based on the timing relationship and reducing a time interval between a register loading and a register unloading in the lane with the larger delay.

3. The method of claim 1, further comprising detecting another lane in the channel with a smaller time delay than other lanes based on the timing relationship and increasing a time interval between a register loading and a register unloading in the lane with a smaller time delay.

4. The method of claim 1, further comprising transmitting a test sequence to the in-line memory modules and setting a timing of register loading and unloading in response to results from the test sequence.

5. The method of claim 1, wherein adjusting is performed in response to timing parameters of a response from the in-line memory modules.

6. The method of claim 1, further comprising compensating for skew across the at least two channels based on a timing of the responses between the at least two channels.

7. The method of claim 1, wherein monitoring comprises detecting an overrun.

8. The method of claim 1, wherein monitoring comprises detecting an underrun.

9. The method of claim 1, wherein monitoring comprises monitoring a timing separation between a load pointer and an unload pointer.

10. An apparatus comprising:
at least one output port to convey a memory retrieval request;
at least two input ports to receive results associated with the memory retrieval request;
a drift compensation module coupled to an input port of the at least two input ports, the drift compensation module to utilize a load command and an unload command to control storage and conveyance of the received results, the load and unload commands having a timing relationship; and
a monitor to monitor system parameters and to send a control signal to the drift compensation module, the control signal to modify the timing relationship based on the system parameters.

11. The apparatus of claim 10, further comprising a deskew module coupled to the drift compensation logic to deskew the received results.

12. The apparatus of claim 11, wherein the received results are received on different channels.

13. The apparatus of claim 10, further comprising bus interface logic coupled to the deskew adjust module.

14. The apparatus of claim 10, further comprising at least two dual in line memory modules coupled to the drift control module.

15. The apparatus of claim 10, wherein the system parameters are data retrieval delays.

16. The apparatus of claim 10, wherein the system parameters comprise a time period between a load and unload control signal.

17. A machine-accessible medium containing instructions to operate a processing system which, when the instructions are executed by a machine, cause said machine to perform operations, comprising:
sending a memory request to at least two in-line memory modules;
receiving a reply to the memory request on at least two lanes and at least two channels;
monitoring the reply to detect data retrieval errors; and
adjusting the timing drift of received data between the at least two lanes by adjusting a timing of a register loading and an unloading sequence in response to the monitoring.

18. The machine-accessible medium of claim 17, which when executed causes the computer to transmit a test sequence and set a timing of the register loading and unloading in response to a reply related to the test sequence.

19. The machine-accessible medium of claim 17, which when executed causes the computer to adjust the timing in response to timing parameters of the received reply.

20. The machine-accessible medium of claim 17, which when executed causes the computer to compensate for skew across the at least two channels based on a timing parameters of the received reply.
